(19) United States
(12) Patent Application Publication
(10) Pub. No.: US 2007/0233802 A1
(43) Pub. Date: Oct. 4, 2007

(54) Methods and arrangements for implementing whisper mode conversations during a multiparty telecommunication session

(75) Inventor: Shreevallabh Kulkarni, Bangalore (IN)

Correspondence Address: KALI LAW GROUP, P. C, P.O. BOX 60187, SUNNYVALE, CA, 94088-0187, US

(73) Assignee: Sonim Technology, Inc., San Mateo, CA (US)

(21) Appl. No.: 11/701,671

(22) Filed: Apr. 3, 2007

Related U.S. Application Data
(60) Provisional application No. 60/764,699, filed on Feb. 2, 2006.

(51) Int. Cl. G06F 15/16

(52) U.S. Cl. 709/207

(57) ABSTRACT

Methods for implementing a whisper mode conversation during a multiparty PoC session are presented, the method including: transmitting a whisper request to a media server by a whisper requester, wherein the whisper request includes a whisper recipient(s), and wherein the whisper requester is a participant in the multiparty PoC session, the media server configured to manage a number of talk bursts occurring over the multiparty PoC session; if the whisper request is granted by the media server, sending a whisper grant to the whisper requester by the media server, and sending a whisper taken to the whisper recipient(s) by the media server, wherein the whisper mode conversation is non-disruptive with respect to the multiparty PoC session; and if the whisper request is denied by the media server, sending a whisper deny to the whisper requester by the media server.

### PRIORITY CLAIM TO PROVISIONAL APPLICATION

A claim for priority is hereby made under the provisions of 35 U.S.C. § 119 for the present application based upon U.S. Provisional Application No. 60/764,699, filed on Feb. 02, 2006, which is incorporated herein by reference.

### BACKGROUND

Technological advances in mobile devices, such as cellular telephones and personal digital assistants (PDAs) have emancipated users by increasing user mobility. Along with these advances in mobility has come a full spectrum of features. Indeed, where once a conference call required users to be physically confined to specific locations having suitable capability, now mobile users may enjoy conferences calls from any cellular accessible location. As may be appreciated, conference calls or multiparty push-to-talk over cellular (PoC) sessions may be constructed using Real-time Transport Protocol (RTP). As discussed herein, RTP refers to a streaming media protocol used for communicating between multiple participants. RTP may be established using a signaling protocol such as Session Initiation Protocol (SIP) based signaling. SIP is a common protocol used for Internet conferencing, telephony, events notification, and instant messaging.

During a conference or multiparty call in a PoC session, voice activity may be governed by a “talk burst control protocol” (TBCP) as defined in the Open Mobile Alliance (OMA), which are herein incorporated by reference. In one example, during a multiparty PoC session, only one participant is generally allowed to talk at a time. When a participant talks, a talk burst is created. The talk burst may then be streamed to the other participants in the multiparty PoC session. Specific details regarding PoC sessions and TBCP may be found in the OMA specifications.

While bursted voice data may provide a satisfactory user experience, a need may occur in which one or more participants may wish to conduct a limited private conversation without disconnecting from the overall session. One conventional method for conducting private conversations may involve temporarily restricting the session to a subset of participants. In this example, any communications between the remaining participants are restricted during private conversation. That is, the remaining participants will be precluded from sending or receiving voice data. Consequently, a session may be halted until all private conversations have been concluded. This method may result in a disrupted session that may hinder effective session communication and decrease a user's call experience.

Another conventional method for conducting private conversations may entail establishing new SIP sessions for each sub-group session. However, multiple SIP sessions are expensive alternatives in terms of bandwidth that may cause latency and network capacity issues. It may be desirable to provide methods which do not suffer from these drawbacks so that a user may carry on a private conversation with a number of participants without hindering the remaining participants.

Therefore, methods and arrangements for implementing whisper mode conversations during a multiparty telecommunication session are presented here.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Embodiments of the present invention provide for non-disruptive whisper conversations during a multiparty push-to-talk-over-cellular (PoC) session. As such, methods for implementing a whisper mode conversation during a multiparty PoC session are presented, the method including: transmitting a whisper request to a media server by a whisper requester, wherein the whisper request includes a whisper recipient(s), and wherein the whisper requester is a participant in the multiparty PoC session, the media server configured to manage a number of talk bursts occurring over the multiparty PoC session; if the whisper request is granted by the media server, sending a whisper grant to the whisper requester by the media server, and sending a whisper taken to the whisper recipient(s) by the media server, wherein the whisper mode conversation is non-disruptive with respect to the multiparty PoC session; and if the whisper request is denied by the media server, sending a whisper deny to the whisper requester by the media server. In some embodiments, methods are presented including: if the whisper request is granted by the media server, sending a whisper talk burst by the whisper requester to the media server, and sending the whisper talk burst by the media server to the whisper recipient(s); sending a whisper release by the whisper requester to the media server; and sending a talk burst control protocol (TBCP) IDLE/TAKEN message to the whisper requester and to the whisper recipient(s) to return the whisper requester and the whisper recipient(s) to the multiparty PoC session. In some embodiments, methods are presented wherein the whisper request, the whisper grant, the whisper deny, and the whisper taken are each enabled to utilize a message that makes use of a TBCP message of a real-time transport control protocol (RTCP) application (APP) packet. In some embodiments, methods are presented wherein the TBCP message selects any one of a reserved value for a subtype field of the RTCP APP packet.

In other embodiments, a push-to-talk-over-cellular (PoC) system configured to provide a multiparty PoC session are presented, the system including: a requesting PoC client for making a whisper request, wherein the requesting PoC client is currently participating in the multiparty PoC session; a media server for negotiating a non-disruptive whisper mode conversation, wherein the media server is configured to send a whisper grant or a whisper deny in response to the whisper request; and a number of receiving PoC clients for participating in the non-disruptive whisper mode conversation, wherein the number of receiving PoC clients are configured to receive a whisper taken in response to the whisper grant. In some embodiments, systems are presented wherein the whisper request, the whisper grant, the whisper deny, and the whisper taken are each enabled to utilize a message that makes use of a TBCP message of a real-time transport control protocol (RTCP) application (APP) packet. In some embodiments, systems are presented wherein the TBCP message selects any one of a reserved value for a subtype field of the RTCP APP packet.

In other embodiments, push-to-talk-over-cellular (PoC) terminals are presented, the terminals including: means for making a whisper request during a multiparty PoC session to initiate a non-disruptive whisper mode conversation; means for receiving a whisper grant from a media server to initiate the non-disruptive whisper mode conversation; means for receiving a whisper deny from a media server to deny the non-disruptive whisper mode conversation; means for sending a whisper talk burst from the PoC terminal to at least one receiving PoC terminal; and means for returning the PoC terminal and the at least one receiving PoC terminal to the multiparty PoC session. In some embodiments, terminals are presented wherein the whisper request, the whisper grant, and the whisper deny are each enabled to utilize a message that makes use of a TBCP message of a real-time transport control protocol (RTCP) application (APP) packet. In some embodiments, terminals are presented wherein the TBCP message selects any one of a reserved value for a subtype field of the RTCP APP packet.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a user interface that may be utilized to initiate a whisper mode conversation in accordance with embodiments of the present invention;

FIG. 2 is an illustrative representation of a flowchart diagramming steps for initiating a whisper mode conversation in accordance with embodiments of the present invention;

FIG. 3 is an illustrative representation of functions of a media server during a whisper mode conversation in accordance with embodiments of the present invention;

FIG. 4 is an illustrative representation of a whisper request message in accordance with embodiments of the present invention;

FIG. 5 is an illustrative representation of a whisper grant message in accordance with embodiments of the present invention;

FIG. 6 is an illustrative representation of a whisper taken message in accordance with embodiments of the present invention; and

FIG. 7 is an illustrative representation of a whisper deny message in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

In accordance with embodiments of the present invention, there is provided a method for implementing a plurality of whisper mode conversations during a multiparty telecommunication session such as a conference call or a multiparty push to talk over cellular (PoC) session. As discussed herein, whisper mode conversations refer to one or more secondary conversations being conducted among a subset of participants of a multiparty telecommunication session. Embodiments of the invention also provide for plurality of whisper mode conversations to be conducted between one or more subsets of participants within the same Session Initiation Protocol (SIP) session without affecting the ongoing communication among the remaining set of participants in the overall multiparty telecommunication session.

The invention is described with reference to specific architectures and protocols. Those skilled in the art will recognize that the description is to provide clarity and understanding of embodiments of the present invention. The description is not meant to be limiting. In an example, reference is made to push-to-talk over cellular (PoC) system; however, this invention may also be applied toward other types of mobile radio networks. Likewise, reference is made to push-to-talk (PTT) calls; however, this invention may also be implemented for other types of Voice over Internet Protocol (VOIP) calls.

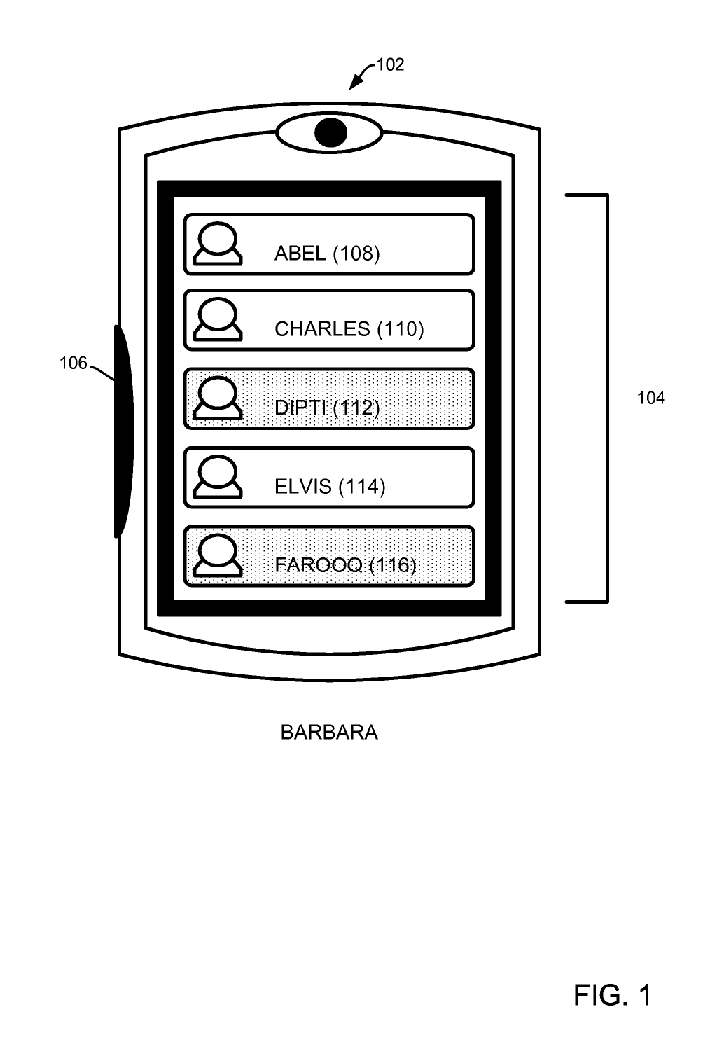

FIG. 1 is an illustrative representation of a user interface that may be utilized to initiate a whisper mode conversation in accordance with embodiments of the present invention. It may be appreciated that the user interface is not intended to be limiting in that any number of suitable interfaces may be utilized without departing from the present invention. The illustrative representation is presented to clarify methods by which embodiments may be practiced. In some embodiments, interface 102 may be configured to provide a list 104 of participants in a normal multiparty telecommunication session. As discussed herein, a normal talk burst refers to stream of data from a multiparty PoC session. Consider the situation wherein, for example, Barbara, whose interface 102 is shown, is participating in a multiparty PoC session with five other participants: Abel 108, Charlie 110, Dipti 112, Elvis 114, and Farooq 116. During the multiparty PoC session, Barbara wishes to speak privately with Dipti 112 and Farooq 116 using her interface 102. To initiate a whisper mode conversation, Barbara may select Dipti 112 and Farooq 116 from list 104 as the recipients of the whisper talk. Then, Barbara may request permission to talk. In one example, a PTT button 106 may be utilized to request permission. Once Barbara has received permission to talk, Barbara may begin talking by utilizing PTT button 106. Once Barbara has ceased talking, Barbara may release PTT button 106 to end the whisper talk burst. Whisper talk bursts, or streams of data from the whisper mode conversation, may then be forwarded to Dipti 112 and Farooq 116. A whisper talk burst incoming notifier such as, for example, a beep tone or a display indicator may notify the recipients that the next incoming message is a whisper talk burst instead of a normal talk burst. Any method of notification well-known in the art may be utilized without departing from present invention.

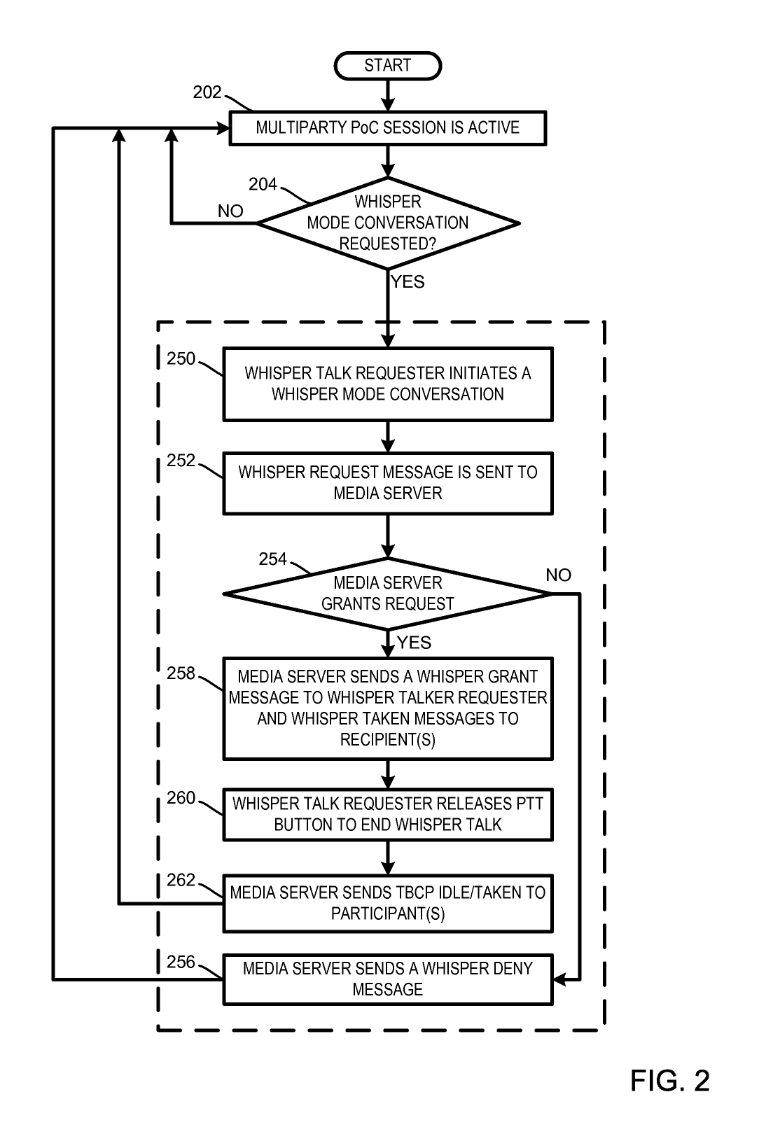

FIG. 2 is an illustrative representation of a flowchart diagramming steps for initiating a whisper mode conversation in accordance with embodiments of the present invention. At a first step 202, a multiparty PoC session is active. As noted above, conference calls or multiparty push-to-talk over cellular (PoC) sessions may be constructed using Real-time Transport Protocol (RTP). As discussed herein, RTP refers to a streaming media protocol used for communicating between multiple participants. RTP may be established using a signaling protocol such as Session Initiation Protocol (SIP) based signaling. SIP is a common protocol used for Internet conferencing, telephony, events notification, and instant messaging. During a conference or multiparty call in a PoC session, voice activity may be governed by a “talk burst control protocol” (TBCP) as defined in the Open Mobile Alliance (OMA). Typically, during a multiparty PoC session, only one participant is generally allowed to talk at a time. When a participant talks, a talk burst is created. The talk burst may then be streamed to the other participants in the multiparty PoC session. Utilizing embodiments of the present invention, a participant may wish to initiate a whisper mode conversation. At a next step 204, the method may determine whether a whisper mode conversation is requested. A whisper mode conversation, in embodiments described herein, creates a sub-group of participants who may receive a talk burst while maintaining a current conference session. Thus, a current session need not wait or terminate to allow a whisper mode conversation. If the method determines at a step 204 that a whisper mode is not requested, then the method returns to a step 202. If the method determines at a step 204 that a whisper mode is requested, then the method continues to steps 250-262 to manage the whisper mode conversation.

Steps 250-262 may be accomplished, in an embodiment, in coordination with a media server. As discussed herein, a media server refers to a computer or a software application responsible for managing talk bursts that may occur during a multiparty PoC session in accordance with OMA standards. At a next step 250, a whisper requester may initiate a whisper mode conversation. As discussed herein, a whisper requester refers to a participant of a multiparty PoC session who wishes to conduct a whisper mode conversation with a subset of participants (or whisper recipients) of the multiparty PoC session. Initiation may include selecting at least one recipient. Once one or more whisper recipients have been selected, whisper requester may, at next step 252, send a whisper request message to a media server. Sending a whisper request message to a media server may be accomplished by using a PTT button, in an embodiment.

At a next step 254, a media server may determine whether to deny or grant a whisper request. If a media server determines at a step 254 to deny a whisper request, then the method continues to a step 256 to send a whisper deny message to a whisper requester. In an embodiment, a whisper request may be denied based on a pre-determined set of criteria that may have been established by a predefined policy. For example, a whisper request may be denied if the request is initiated during transmission of a normal talk bursts or if the request is not authorized by the recipient. In another example, a whisper request may be denied or alternatively queued by the media server if a whisper recipient is currently part of another sub-group session such as another whisper sub-group. A whisper deny message may include a reason for the denial so that a whisper requester may be informed as to the reasons why a whisper request was denied. If a whisper request is queued by a media server, the media server may send a whisper queue message to indicate the whisper request's position in the queue. Any number of policies may be implemented without departing from present invention. From a step 256, the method continues to a step 202 to continue in the ongoing multiparty PoC session.

If the method determines at a step 254 to grant a whisper request, then the media server grants the whisper request and transmits a whisper grant message to the whisper requester and to each whisper recipient. Whisper taken messages may include a notification from the media server indicating that a whisper recipient will be receiving a whisper talk burst. A whisper requester may then depress their PTT button and begin speaking. When a whisper requester has finished talking, the whisper requester may release PTT button at a next step 260 to indicate to the media server that the whisper talk burst stream is over whereupon the whisper talk burst fork inside the media server may be torn down. In some embodiments, a whisper release message may be transmitted to the media server by the whisper requester. As described herein, a whisper release message is a message informing a media server that the requester has finished talking. At a next step 262, the media server may send a TBCP idle or taken message to each participant related to the status of the active multiparty PoC session. Once the TBCP idle/taken message has been transmitted, the method continues to a step 202.

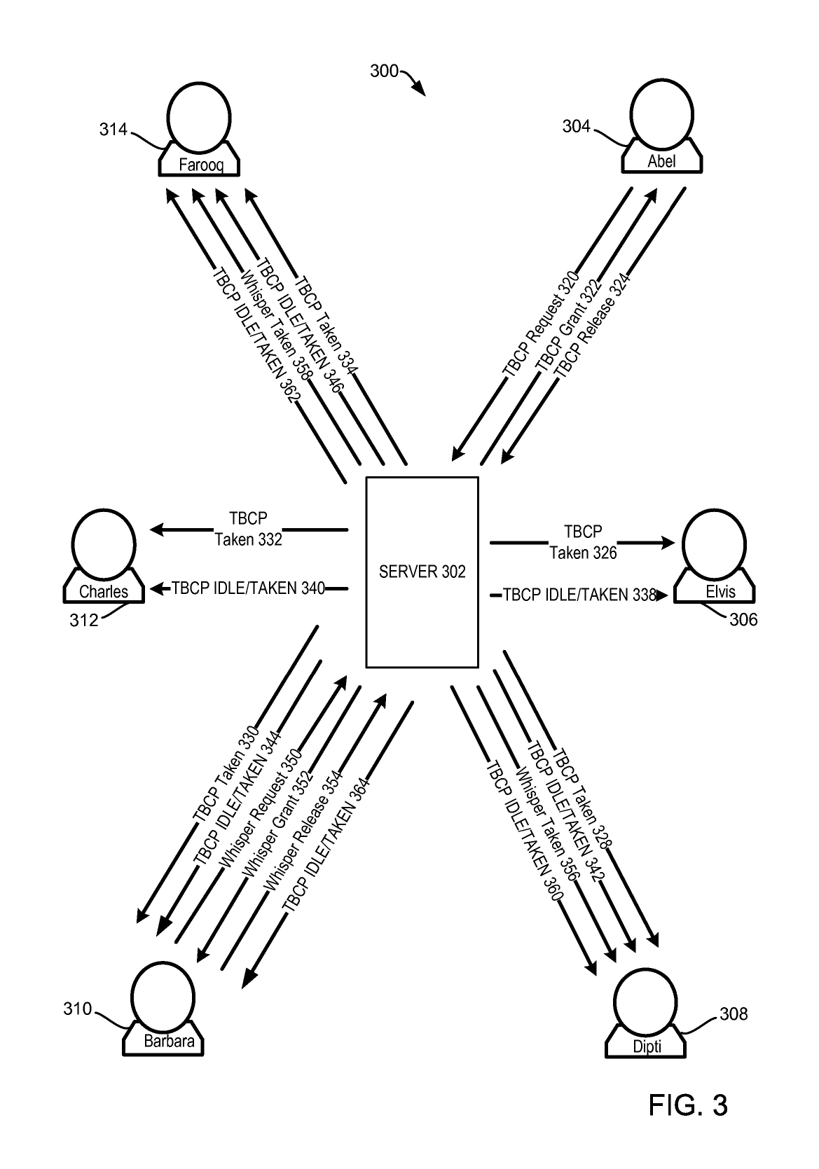

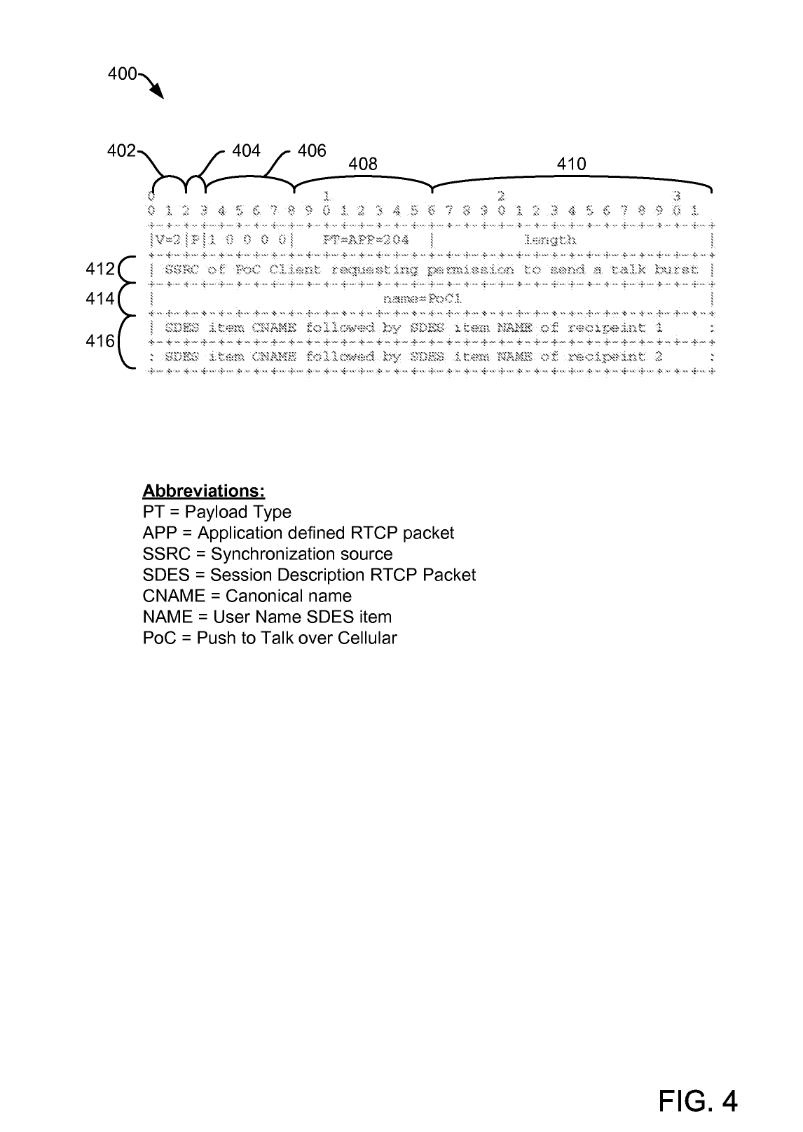

FIG. 3 is an illustrative representation of functions of a media server during a whisper mode conversation in accordance with embodiments of the present invention. Multiparty PoC session 300 illustrates an example scenario as described above for FIG. 1. Furthermore, FIG. 3 is discussed in combination with FIGS. 4-7. During a multiparty PoC session 300, a media server 302 may receive and send a plurality of TBCP requests. In the illustrated example, Barbara 310 is a whisper requester while Dipti 308 and Farooq 314 are whisper recipients, all of whom are participants in multiparty PoC session 300. Additionally, Abel 304, Charles 312, and Elvis 306 are participants in multiparty PoC session 300. In the illustrated example, Abel 304 has sent a TBCP request message 320 to media server 302. If no data stream is currently being transmitted, media server 302 may send a TBCP grant message 322 to allow Abel 304 to begin transmitting. Meanwhile, media server 302 may send TBCP taken messages (326, 328, 330, 332, and 334) to the other participants (Elvis 306, Dipti 308, Barbara 310, Charles 312, and Farooq 314) to inform them that Abel 304 has currently requested the floor. After Abel 304 has finished talking, a TBCP release message 324 may be sent to media server 302 to indicate that the talk burst sent by Abel 304 is complete. Media server 302 may then send TBCP idle messages (338, 340, 342, 344, and 346) to all participants in the multiparty PoC session order to open the floor for others who may request the floor at any time.

If Barbara 310 in the meantime wishes to conduct a whisper conversation with a subset of participants during the multiparty PoC session, Barbara 310 may send a whisper request message 350 to media server 302. FIG. 4 is an illustrative representation of a whisper request message in accordance with embodiments of the present invention. In some embodiments, whisper request message 400 is similar to a TBCP request message. As illustrated, the first 2-bit field 402 is for a version of RTP (Real-time Transport Protocol) (version=2, in the case of the present invention). The second bit field 404 is for a padding bit. It can be seen that, if the padding bit is given, one or two padding octets that are not contained in a payload are added. The third 5-bit field 406 denotes a subtype (see an OMA PoC user plane specification). To distinguish a whisper request message from a TBCP request message, the subtype 406 may be different or an additional Option ID may be inserted in a typical TBCP request message. It can be seen which function of the TBCP the RTCP APP packet performs using the subtype. For example, in the specification that is currently drafted in the OMA, the subtype has values defined as 00000 for a TBCP Talk Burst Request message, as 00011 for a TBCP Talk Burst Deny message, as 00001 for a TBCP Talk Burst Granted message, and as 00010 or 10010 for a TBCP Talk Burst Taken message. Since 16 TBCP Talk Burst Control messages are defined as of now, the subtype values are defined up to 01111. The remaining 16 values are reserved for the TBCP Talk Burst Control messages to be newly created in the future. Thus, in embodiments of the present invention, the subtype value is given as any one selected from the values from 10000 to 11111, so that each of the TBCP Talk Burst Control messages can be discriminated from the other TBCP Talk Burst Control messages. Herein, the TBCP Talk Burst Control message will be discriminated from the others using 10000, one of the remaining subtype values.

The fourth 1-byte field 408 is for a payload type (PT), and is shown as PT=204, which designates a control format of RTCP, as is well-known. The fifth 2-byte field 410 is for a length field. If a value of 2 is used in this field, this indicates that the message has two 4-byte octets. If the value is followed by the payload, this indicates a length of the payload, i.e. how many a total of 4-byte octets exist in the payload field. The sixth 4-byte field 412 is for a synchronization source (SSRC) field. This field makes it possible to discriminate who makes a request for a whisper session. The seventh 4-byte field 414 is expressed by ASCII, which indicates that the packet is used in the PoC version 1. The remaining fields 416 are for application specific information. In some embodiments, a whisper request message may include a list of selected recipient(s) 416.

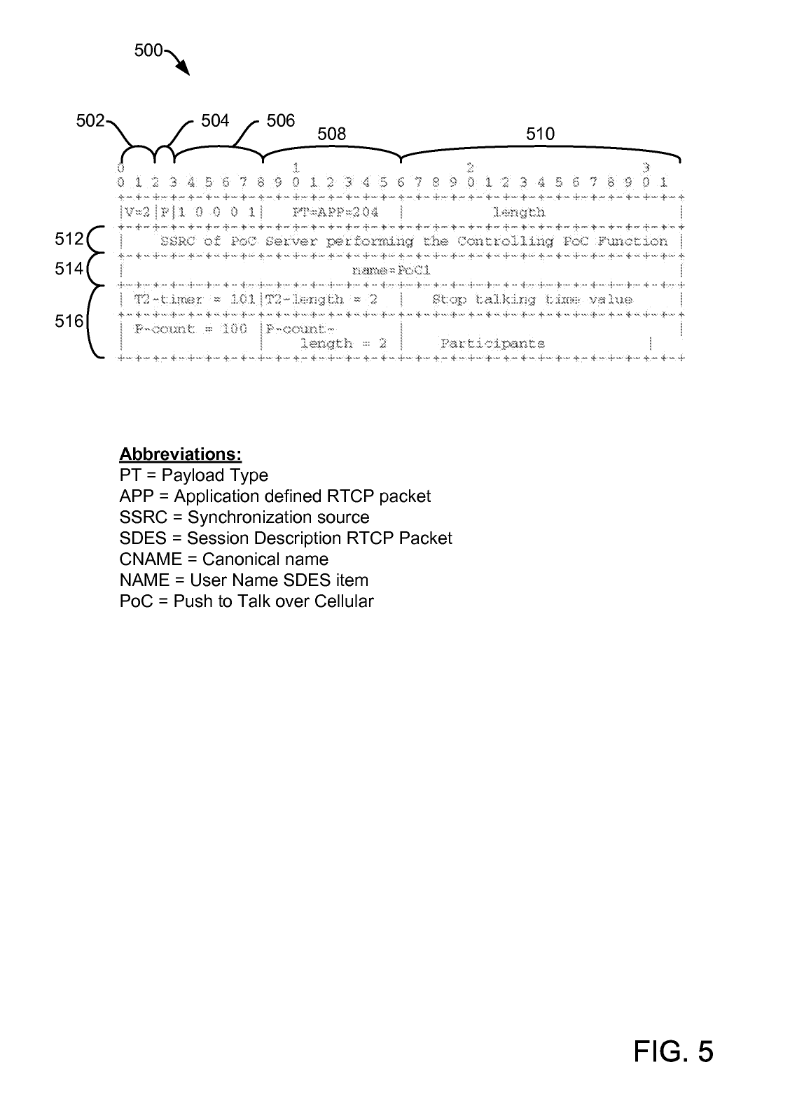

Returning to FIG. 3, if media server 302 accepts the whisper request, then a whisper grant message 352 may be sent to Barbara 310 to inform her that she may begin talking. FIG. 5 is an illustrative representation of a whisper grant message in accordance with embodiments of the present invention. In some embodiments, whisper grant message 500 is similar to a TBCP grant message. As illustrated, the first 2-bit field 502 is for a version of RTP (Real-time Transport Protocol) (version=2, in the case of the present invention). The second bit field 504 is for a padding bit. It can be seen that, if the padding bit is given, one or two padding octets that are not contained in a payload are added. The third 5-bit field 506 denotes a subtype (see an OMA PoC user plane specification). To distinguish a whisper grant message from a TBCP grant message, the subtype 506 may be different or an additional Option ID may be inserted in a typical TBCP grant message. It can be seen which function of the TBCP the RTCP APP packet performs using the subtype. For example, in the specification that is currently drafted in the OMA, the subtype has values defined as 00000 for a TBCP Talk Burst Request message, as 00011 for a TBCP Talk Burst Deny message, as 00001 for a TBCP Talk Burst Granted message, and as 00010 or 10010 for a TBCP Talk Burst Taken message. Since 16 TBCP Talk Burst Control messages are defined as of now, the subtype values are defined up to 01111. The remaining 16 values are reserved for the TBCP Talk Burst Control messages to be newly created in the future. Thus, in embodiments of the present invention, the subtype value is given as any one selected from the values from 10000 to 11111, so that each of the TBCP Talk Burst Control messages can be discriminated from the other TBCP Talk Burst Control messages. Herein, the TBCP Talk Burst Control message will be discriminated from the others using 10000, one of the remaining subtype values.

The fourth 1-byte field 508 is for a payload type (PT), and is shown as PT=204, which designates a control format of RTCP, as is well-known. The fifth 2-byte field 510 is for a length field. If a value of 2 is used in this field, this indicates that the message has two 4-byte octets. If the value is followed by the payload, this indicates a length of the payload, i.e. how many a total of 4-byte octets exist in the payload field. The sixth 4-byte field 512 is for a synchronization source (SSRC) field. This field makes it possible to discriminate who makes a request for a whisper session. The seventh 4-byte field 514 is expressed by ASCII, which indicates that the packet is used in the PoC version 1. The remaining fields 516 are for application specific information. In some embodiments, a whisper grant message may include a t2-timer field, a t2-length field, a stop talking time value field, a p-count field, a p-count length field, and a participants field.

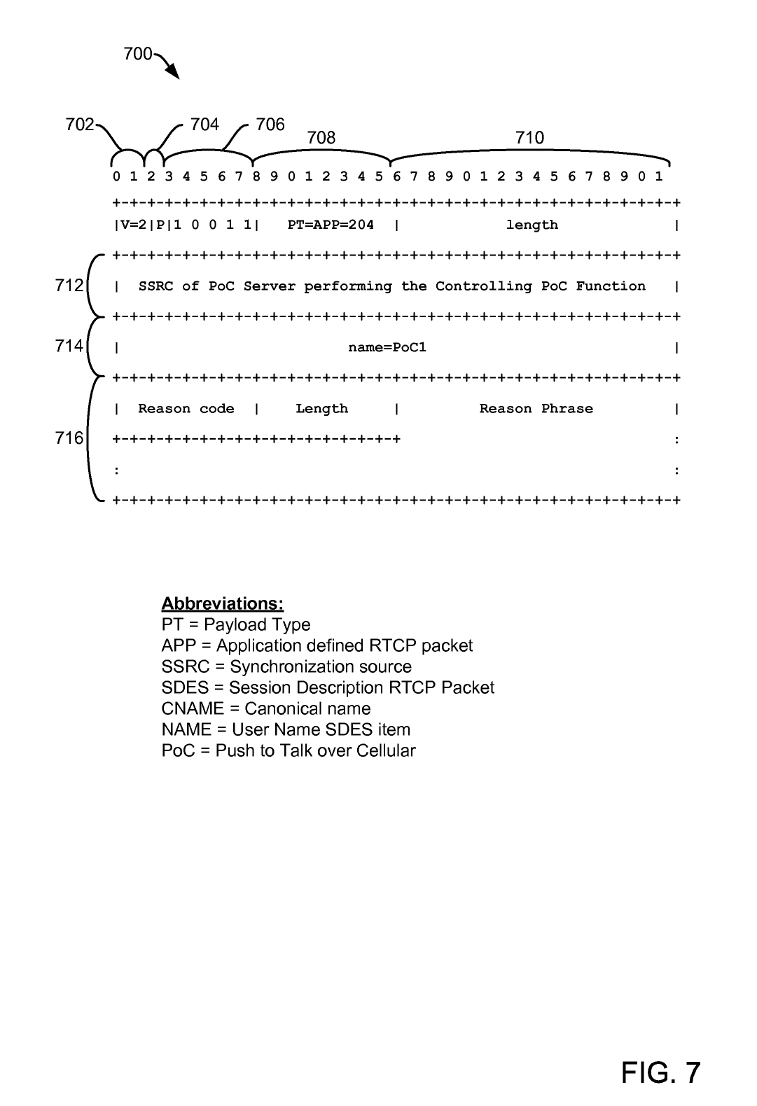

In addition, FIG. 7 is an illustrative representation of a whisper deny message in accordance with embodiments of the present invention. In some embodiments, whisper deny message 700 is similar to a TBCP deny message. As illustrated, the first 2-bit field 702 is for a version of RTP (Real-time Transport Protocol) (version=2, in the case of the present invention). The second bit field 704 is for a padding bit. It can be seen that, if the padding bit is given, one or two padding octets that are not contained in a payload are added. The third 7-bit field 706 denotes a subtype (see an OMA PoC user plane specification). To distinguish a whisper deny message from a TBCP deny message, the subtype 706 may be different or an additional Option ID may be inserted in a typical TBCP deny message. It can be seen which function of the TBCP the RTCP APP packet performs using the subtype. For example, in the specification that is currently drafted in the OMA, the subtype has values defined as 00000 for a TBCP Talk Burst Request message, as 00011 for a TBCP Talk Burst Deny message, as 00001 for a TBCP Talk Burst Granted message, and as 00010 or 10010 for a TBCP Talk Burst Taken message. Since 16 TBCP Talk Burst Control messages are defined as of now, the subtype values are defined up to 01111. The remaining 16 values are reserved for the TBCP Talk Burst Control messages to be newly created in the future. Thus, in embodiments of the present invention, the subtype value is given as any one selected from the values from 10000 to 11111, so that each of the TBCP Talk Burst Control messages can be discriminated from the other TBCP Talk Burst Control messages. Herein, the TBCP Talk Burst Control message will be discriminated from the others using 10000, one of the remaining subtype values.

The fourth 1-byte field 708 is for a payload type (PT), and is shown as PT=204, which designates a control format of RTCP, as is well-known. The fifth 2-byte field 710 is for a length field. If a value of 2 is used in this field, this indicates that the message has two 4-byte octets. If the value is followed by the payload, this indicates a length of the payload, i.e. how many a total of 4-byte octets exist in the payload field. The sixth 4-byte field 712 is for a synchronization source (SSRC) field. This field makes it possible to discriminate who makes a request for a whisper session. The seventh 4-byte field 714 is expressed by ASCII, which indicates that the packet is used in the PoC version 1. The remaining fields 716 are for application specific information. In some embodiments, a whisper deny message may include a reason code field, a length field, and a reason phrase field.

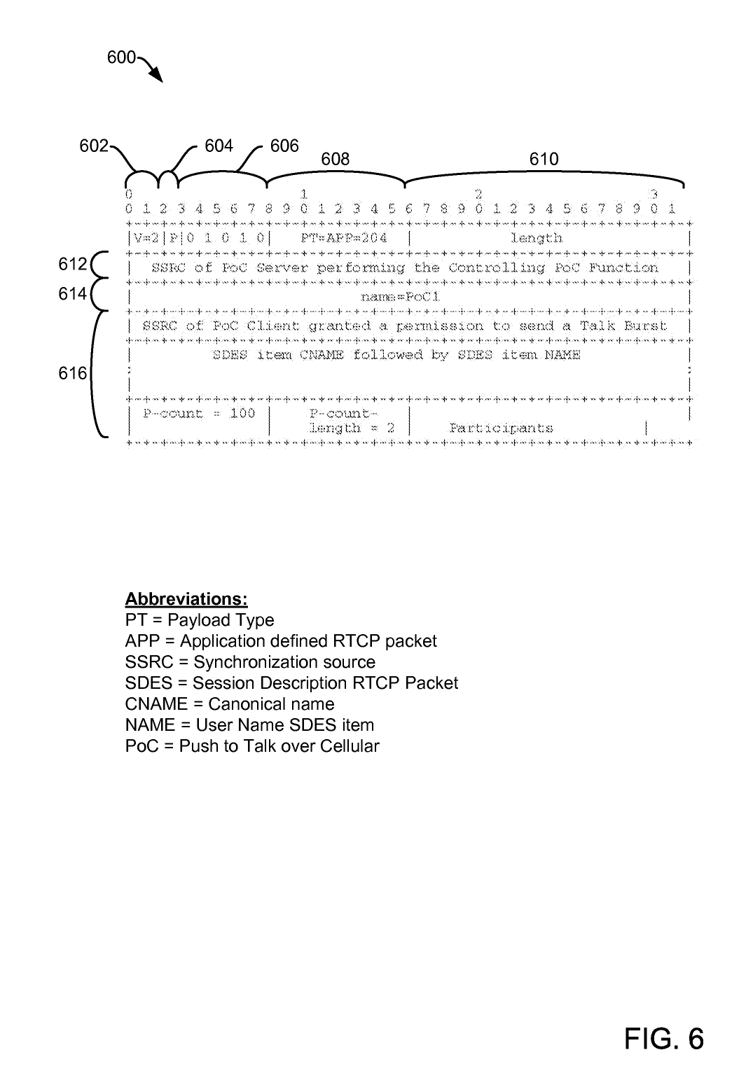

Returning to FIG. 3, media server 302 may also send whisper taken messages (356 and 358) to the selected recipients (Dipti 308 and Farooq 314). As mentioned above, a whisper taken message is a notification to each whisper recipient that a whisper talk burst may be forthcoming. FIG. 6 is an illustrative representation of a whisper taken message in accordance with embodiments of the present invention. Whisper taken message 600 is similar to a TBCP taken message. As illustrated, the first 2-bit field 602 is for a version of RTP (Real-time Transport Protocol) (version=2, in the case of the present invention). The second bit field 604 is for a padding bit. It can be seen that, if the padding bit is given, one or two padding octets that are not contained in a payload are added. The third 5-bit field 606 denotes a subtype (see an OMA PoC user plane specification). To distinguish a whisper taken message from a TBCP taken message, the subtype 606 may be different or an additional Option ID may be inserted in a typical TBCP taken message. It can be seen which function of the TBCP the RTCP APP packet performs using the subtype. For example, in the specification that is currently drafted in the OMA, the subtype has values defined as 00000 for a TBCP Talk Burst Request message, as 00011 for a TBCP Talk Burst Deny message, as 00001 for a TBCP Talk Burst Granted message, and as 00010 or 10010 for a TBCP Talk Burst Taken message. Since 16 TBCP Talk Burst Control messages are defined as of now, the subtype values are defined up to 01111. The remaining 16 values are reserved for the TBCP Talk Burst Control messages to be newly created in the future. Thus, in embodiments of the present invention, the subtype value is given as any one selected from the values from 10000 to 11111, so that each of the TBCP Talk Burst Control messages can be discriminated from the other TBCP Talk Burst Control messages. Herein, the TBCP Talk Burst Control message will be discriminated from the others using 10000, one of the remaining subtype values.

The fourth 1-byte field 608 is for a payload type (PT), and is shown as PT=204, which designates a control format of RTCP, as is well-known. The fifth 2-byte field 610 is for a length field. If a value of 2 is used in this field, this indicates that the message has two 4-byte octets. If the value is followed by the payload, this indicates a length of the payload, i.e. how many a total of 4-byte octets exist in the payload field. The sixth 4-byte field 612 is for a synchronization source (SSRC) field. This field makes it possible to discriminate who makes a request for a whisper session. The seventh 4-byte field 614 is expressed by ASCII, which indicates that the packet is used in the PoC version 1. The remaining fields 616 are for application specific information. In some embodiments, a whisper taken message may include a SSRC client field, a SDES item CNAME field, a p-count field, a p-count length field, and a participants field.

Returning to FIG. 3, once Barbara 310 has finished, a whisper release message 354 may be sent to media server 302. Upon receiving whisper release message 354, media server 302 may transmit TBCP idle message (360, 362 and 364) to the whisper session participants (Barbara 310, Dipti 308 and Farooq 314). In an embodiment, whisper talk bursts may have priority over normal talk bursts. Thus, transmission of normal talk bursts to the subset of participants in the whisper mode conversation may be halted until the whisper mode conversation has been concluded. In the described whisper conversation example, Charles 312 and Elvis 306 may continue to receive normal talk bursts from Abel 304 while Dipti 308 and Farooq 314 may only hear whisper talk bursts sent by Barbara 310 during a whisper mode conversation. Once the whisper talk burst is concluded, Barbara 310, Dipti 308 and Farooq 314 will then receive a TBCP taken message (364, 360 and 362) and start to receive the talk burst in the multiparty PoC session instead. As such, normal multiparty telecommunication session is not disrupted nor is an additional Session Initiation Protocol (SIP) session required to enable whisper mode conversations.

As can be appreciated from the embodiments of the invention, a plurality of whisper mode conversations may be conducted during a multiparty PoC session without affecting the ongoing normal talk. With whisper mode conversations, participants have a richer user experience because participants may conduct private conversations without interrupting the multiparty PoC session. Additionally, whisper mode conversations are more cost effective than prior arts in that private conversations may be conducted within a single SIP session.

While this invention has been described in terms of several preferred embodiments, there are alterations, permutations, and equivalents, which fall within the scope of this invention. It should also be noted that there are many alternative ways of implementing the methods and apparatuses of the present invention. Although various examples are provided herein, it is intended that these examples be illustrative and not limiting with respect to the invention. For example, the packet formats provided are utilized for illustrative purposes only and may take any of a number of forms so that changes in the OMA standard may be accommodated without departing from the present invention. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for implementing a whisper mode conversation during a multiparty push-to-talk-over-cellular (PoC) session, the method comprising:
transmitting a whisper request to a media server by a whisper requester, wherein the whisper request includes at least one whisper recipient, and wherein the whisper requester is a participant in the multiparty PoC session, the media server configured to manage a plurality of talk bursts occurring over the multiparty PoC session;
if the whisper request is granted by the media server,
sending a whisper grant to the whisper requester by the media server, and
sending a whisper taken to the at least one whisper recipient by the media server, wherein the whisper mode conversation is non-disruptive with respect to the multiparty PoC session; and
if the whisper request is denied by the media server,
sending a whisper deny to the whisper requester by the media server.

2. The method of claim 1 further comprising:
if the whisper request is granted by the media server,
sending a whisper talk burst by the whisper requester to the media server, and
sending the whisper talk burst by the media server to the at least one whisper recipient;
sending a whisper release by the whisper requester to the media server; and
sending a talk burst control protocol (TBCP) IDLE/TAKEN message to the whisper requester and to the at least one whisper recipient to return the whisper requester and the at least one whisper recipient to the multiparty PoC session.

3. The method of claim 1 wherein granting the whisper request and denying the whisper request is contingent upon a predefined policy.

4. The method of claim 3 wherein the predefined policy comprises:
granting the whisper request if the at least one whisper recipient is configured to accept the whisper mode conversation;
denying the whisper request if the at least one whisper recipient is currently a member of a second whisper mode conversation;
denying the whisper request if any of the at least one whisper recipient does not authorize the whisper mode conversation;
denying the whisper request if the multiparty PoC session is currently sending a multiparty talk burst;
queuing the whisper request if any of the at least one whisper recipient is currently a member of a second whisper mode conversation; and
queuing the whisper request if the multiparty PoC session is currently sending the multiparty talk burst.

5. The method of claim 4 further comprising:
if the whisper request is denied by the media server,
sending a whisper deny message to the whisper requester, the whisper deny message including a reason for the denying the whisper request; and
if the whisper request is queued by the media server,
sending a whisper queue message to the whisper requester, the whisper queue message configured to provide the whisper requester a current whisper request queue position from the queuing the whisper request.

6. The method of claim 1 wherein the whisper request, the whisper grant, the whisper deny, and the whisper taken are each enabled to utilize a message that makes use of a TBCP message of a real-time transport control protocol (RTCP) application (APP) packet.

7. The method of claim 6 wherein the TBCP message selects any one of a reserved value for a subtype field of the RTCP APP packet.

8. A push-to-talk-over-cellular (PoC) system configured to provide a multiparty PoC session, the system comprising:
a requesting PoC client for making a whisper request, wherein the requesting PoC client is currently participating in the multiparty PoC session;
a media server for negotiating a non-disruptive whisper mode conversation, wherein the media server is configured to send a whisper grant or a whisper deny in response to the whisper request; and
a plurality of receiving PoC clients for participating in the non-disruptive whisper mode conversation, wherein the plurality of receiving PoC clients are configured to receive a whisper taken in response to the whisper grant.

9. The system of claim 8 wherein the whisper request, the whisper grant, the whisper deny, and the whisper taken are each enabled to utilize a message that makes use of a TBCP message of a real-time transport control protocol (RTCP) application (APP) packet.

10. The system of claim 9 wherein the TBCP message selects any one of a reserved value for a subtype field of the RTCP APP packet.

11. The system of claim 8 wherein the media server is configured to,
grant the whisper request if the plurality of receiving PoC clients is configured to accept the whisper mode conversation;
deny the whisper request if any of the plurality of receiving PoC clients is currently a member of a second whisper mode conversation;
deny the whisper request if any the plurality of receiving PoC clients does not authorize the whisper mode conversation;
deny the whisper request if the multiparty PoC session is currently sending a multiparty talk burst;
queue the whisper request if any of the plurality of receiving PoC clients is currently a member of a second whisper mode conversation; and
queue the whisper request if the multiparty PoC session is currently sending the multiparty talk burst.

12. A push-to-talk-over-cellular (PoC) terminal comprising:
means for making a whisper request during a multiparty PoC session to initiate a non-disruptive whisper mode conversation;
means for receiving a whisper grant from a media server to initiate the non-disruptive whisper mode conversation;
means for receiving a whisper deny from a media server to deny the non-disruptive whisper mode conversation;
means for sending a whisper talk burst from the PoC terminal to at least one receiving PoC terminal; and
means for returning the PoC terminal and the at least one receiving PoC terminal to the multiparty PoC session.

13. The PoC terminal of claim 12 wherein the whisper request, the whisper grant, and the whisper deny are each enabled to utilize a message that makes use of a TBCP message of a real-time transport control protocol (RTCP) application (APP) packet.

14. The PoC terminal of claim 13 wherein the TBCP message selects any one of a reserved value for a subtype field of the RTCP APP packet.
